(19) United States
(12) Patent Application Publication
(10) Pub. No.: US 2015/0371376 A1
(43) Pub. Date: Dec. 24, 2015

(54) CONTROL APPARATUS, CONTROL METHOD, AND STORAGE MEDIUM

(71) Applicant: CANON KABUSHIKI KAISHA, Tokyo (JP)

(72) Inventor: Keiji Adachi, Kawasaki-shi (JP)

(21) Appl. No.: 14/738,170

(22) Filed: Jun. 12, 2015

(30) Foreign Application Priority Data
Jun. 20, 2014 (JP) 2014-127534

(51) Int. Cl. G06T 7/00; H04N 5/232; G06K 9/00

(52) U.S. Cl. CPC G06T 7/004; G06K 9/00214; H04N 5/23219; H04N 5/23222; G06T 2207/10004; G06T 2207/30196

(57) ABSTRACT

Method(s), control apparatus(es) and storage medium(s) for controlling a zooming operation of an imaging unit according to settings relating to video recognition processing are provided herein. In one or more embodiments, a zoom control unit or an acquisition unit of at least one control apparatus acquires a parameter, such as size information, relating to a size designated for recognition processing to be performed on image data obtained through a shooting operation of an imaging unit, and the zoom control unit or a change unit restricts the change in zoom magnification of the imaging unit according to the acquired parameter. The control apparatus may include: (i) a change unit for changing the size corresponding to the parameter or size information according to a change in the zoom magnification; and (ii) a determination unit for determining a zoom magnification changeable range of the imaging unit according to the size information.

### BACKGROUND OF THE INVENTION

1. Field of the Invention

The present inventions relate to at least one method, at least one control apparatus and at least one storage medium for controlling a zooming operation of an imaging unit according to settings relating to video recognition processing.

2. Description of the Related Art

As technique applicable to a monitoring system or a monitoring camera system, there is a conventionally known object detection technique capable of detecting a specific object included in video. Further, moving object tracking technique capable of following up a detected object is also conventionally known.

In general, in detecting a specific object (e.g., a face or a human body) from video obtained by a monitoring camera, it has been conventionally performed to detect an object that coincides with any one of a plurality of collation patterns (dictionaries), which has been prepared beforehand to store characteristic features of the specific object, from a detection target area in the video. As discussed in Japanese Patent Application Laid-Open No. 2007-135115, it is conventionally known that a specific object can be detected by performing associating processing between a reduced image (i.e., a layer) of captured video and a collation pattern.

However, if the zoom magnification is changed, appropriately performing recognition processing on video may be unfeasible. For example, to detect a specific object from captured video, it may be useful to set a maximum size and a minimum size of a detection target object. In this case, an object detected from the captured video can be recognized as the specific object if the detected object is smaller than the maximum size and greater than the minimum size.

In the above-described case, if a user changes the zoom magnification after completing the setting of the maximum size and the minimum size, it may be unfeasible to obtain the above-mentioned user's expecting detection result of the specific object. More specifically, if the zoom magnification has once changed, the size of an object detected from captured video is different from that of the object to be detected before the zoom magnification is changed. On the other hand, the maximum size and the minimum size remain the same regardless of variation in the zoom magnification. Therefore, detecting an object having a user's expecting size may fail.

### SUMMARY OF THE INVENTION

An aspect of the present inventions provides at least one control apparatus including an acquisition unit configured to acquire size information designated by a user, which is information about a size designated for recognition processing to be performed on an image captured by an imaging unit, a change unit configured to change the size corresponding to the size information acquired by the acquisition unit according to a change in zoom magnification of the imaging unit, and a determination unit configured to determine a zoom magnification changeable range of the imaging unit according to the size information acquired by the acquisition unit.

According to other aspects of the present inventions, one or more additional control apparatuses, one or more control methods and one or more storage mediums are discussed herein. Further features of the present inventions will become apparent from the following description of exemplary embodiments with reference to the attached drawings.

### BRIEF DESCRIPTION OF THE DRAWINGS

FIG. 1 illustrates a configuration of a video processing system according to an exemplary embodiment.

FIG. 2 is a block diagram illustrating a configuration example of a control apparatus according to an exemplary embodiment.

FIG. 3 illustrates a configuration example of information that can be managed by a locus managing unit according to an exemplary embodiment.

FIGS. 4A and 4B illustrate associated object and human body examples.

FIGS. 5A to 5D illustrate human body detection size setting processing.

FIGS. 6A, 6B, and 6C illustrate configuration examples of the parameters.

FIG. 7 is a flowchart illustrating an operation that can be performed by the control apparatus according to the exemplary embodiment.

FIG. 8 is a flowchart illustrating a procedure of zoom magnification changeable range calculation processing according to an exemplary embodiment.

FIG. 9 is a flowchart illustrating a procedure of zoom magnification change processing according to an exemplary embodiment.

FIG. 10 illustrates a function configuration of the control apparatus according to an exemplary embodiment.

### DESCRIPTION OF THE EMBODIMENTS

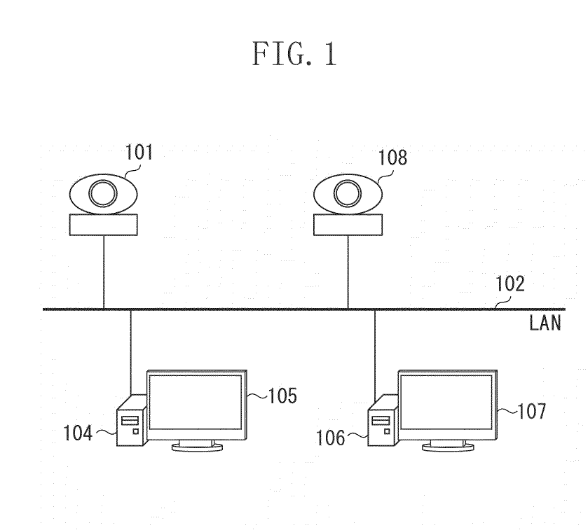

Hereinafter, an exemplary embodiment of the present inventions will be described in detail below with reference to attached drawings. FIG. 1 illustrates a configuration of a video processing system that includes two cameras 101 and 108 each including an optical zooming mechanism, a network 102 constituted by a local area network (LAN), two personal computers (PCs) 104 and 106, and two display apparatuses (i.e., display devices) 105 and 107.

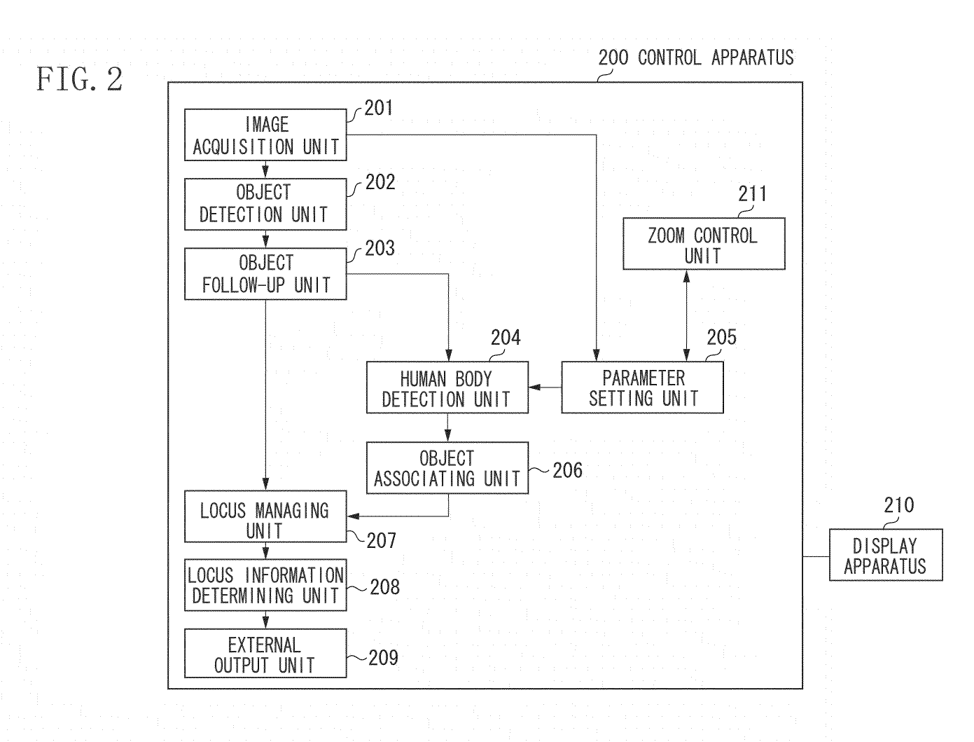

A configuration example of a control apparatus 200 according to the present exemplary embodiment will be described in detail below with reference to FIG. 2. In the present exemplary embodiment, the control apparatus 200 is the camera 101, as described in detail below. However, the PC 104 can serve as the control apparatus 200. Further, the control apparatus 200 can be constituted by an image processing circuit installed in a camera or any other device that can capture moving images. The control apparatus 200 according to the present exemplary embodiment is functionally operable as a device configured to cause a display apparatus 210 to display a setting screen on a display screen thereof that enables a user to set detection parameters required to perform human body detection processing. The display apparatus 210 corresponds to the display apparatus 105 illustrated in FIG. 1.

Further, the control apparatus 200 according to the present exemplary embodiment is a moving image processing apparatus capable of processing moving images. Further, the control apparatus 200 is operable as an image processing apparatus that can process a moving image as still images or can process still images acquired from external devices.

The control apparatus 200 includes an image acquisition unit 201, an object detection unit 202, an object follow-up unit 203, a human body detection unit 204, a parameter setting unit 205, an object associating unit 206, a locus managing unit 207, and a locus information determining unit 208. Further, the control apparatus 200 includes an external output unit 209 and a zoom control unit 211 configured to control a zooming mechanism of an imaging unit. Further, the control apparatus 200 is connected to the display apparatus 210 that can be configured to include a liquid crystal screen. The display apparatus 210 can display images and texts (characters) to express processing result of the control apparatus 200. Hereinafter, an operation to display a moving image on the display screen of the display apparatus 210 will be described in detail below.

The image acquisition unit 201 can acquire a moving image or a still image supplied from an internal imaging sensor or from an external device and can output the acquired moving image or still image to the object detection unit 202.

When the acquired image is a moving image, the image acquisition unit 201 successively outputs an image of each frame that constitutes the moving image to the object detection unit 202. When the acquired image is a still image, the image acquisition unit 201 outputs the acquired still image to the object detection unit 202. The source capable of supplying a moving image or a still image is not restricted to a specific source. Further, the image acquisition unit 201 can acquire a moving image or a still image from a server apparatus or an imaging apparatus that can supply the moving image or the still image via a wired or wireless communication path. Further, the image acquisition unit 201 can be configured to acquire a moving image or a still image from a built-in memory of the control apparatus 200.

The object detection unit 202 can detect a substance (i.e., an object) from a piece of image (or a frame) acquired from the image acquisition unit 201 according to a background subtraction method. Further, the object detection unit 202 can create object information about the detected object and output the created object information to the object follow-up unit 203. The object information includes positional information about each object in frame, bounding rectangle information, and size information about the object. The object detection processing to be performed by the object detection unit 202 is not limited to a specific method. Therefore, any appropriate method other than the background subtraction method is employable to detect an object.

The object follow-up unit 203 can associate an object in a frame of interest (i.e., a processing target frame) with an object in a one-frame preceding frame in relation to the frame of interest, based on the object information acquired from the object detection unit 202. When a similar human object is detected from a different frame, the object follow-up unit 203 according to the present exemplary embodiment can perform associating processing between two objects by allocating a same object ID to the corresponding objects in respective frames. For example, when the object detection unit 202 detects a human object from an image of one-frame preceding frame in relation to the frame of interest, the object follow-up unit 203 allocates a unique object ID (e.g., ID=A) to the detected human object. Then, if the object detection unit 202 detects a similar human object from the frame-of-interest image, the object follow-up unit 203 allocates the same object ID (i.e., ID=A) to the human object detected from the frame of interest. As mentioned above, in a case where similar objects have been detected from a plurality of frames, the object follow-up unit 203 allocates the same object ID to respective objects. If a different object is newly detected from the frame of interest, the object follow-up unit 203 allocates a new object ID to the newly detected object.

A moving vector method is employable when the object follow-up unit 203 identifies similar objects appearing in a plurality of frames. More specifically, according to the moving vector method, the object follow-up unit 203 obtains information about moving speed and direction of an object detected from a first frame and estimates the position of the object in a second frame that follows the first frame. Then, if the distance between the above-mentioned estimated position and an actual position of the object detected from the second frame is smaller than a predetermined distance, the object follow-up unit 203 regards the compared two objects as being similar to each other.

However, the method for associating two or more similar objects detected from a plurality of frames is not limited to the above-mentioned method. For example, it is useful to refer to any one of color, shape, and size (or area) in associating two objects with each other between different frames if they show a higher correlation with respect to the referred feature. Further, it is useful to use both of the above-mentioned two methods (i.e., the method using the moving vector and the method using the correlation with respect to object color/shape/size (or area)).

The human body detection unit 204 can perform human body detection processing on a specific area in which the object detection unit 202 has detected an object, which is one of a plurality of human body detection areas being set beforehand in the frame of interest. The parameter setting unit 205 can set each human body detection area according to a user operation. Further, the parameter setting unit 205 can set a maximum size and a minimum size of each detection target human body according to a user operation. Setting the maximum size and the minimum size of each detection target human body is useful to reduce the processing load relating to the human body detection and lower the possibility of error detection.

More specifically, the human body detection unit 204 acquires parameters (e.g., human body detection area and human body maximum size/minimum size), which are required to perform recognition processing (human body detection) on image data obtained through a shooting operation of the imaging unit, from the parameter setting unit 205. Further, the human body detection unit 204 can perform recognition processing according to the acquired parameters. In the present exemplary embodiment, an example of the recognition processing is human body detection processing. However, the recognition processing is not limited to the above-mentioned example. For example, the detection target can be a human face, an automobile, or an animal. Further, an appropriate configuration capable of detecting a plurality of types of specific objects is employable.

The human body detection unit 204 according to the present exemplary embodiment can detect a human body from a frame with reference to pattern images held in the control apparatus 200 for the human body detection processing. However, the method using the pattern images is replaceable by any other appropriate human body detection algorithm.

Further, the above-mentioned example is characterized by detecting a human body from an overlap area between the area in which a target object has been detected by the object detection unit 202 and the human body detection area set by the parameter setting unit 205. However, the human body detection processing according to the present exemplary embodiment is not limited to the above-mentioned example. For example, it is feasible to omit the object detection processing to be performed by the object detection unit 202 if the parameter setting unit 205 is configured to perform the human body detection processing on the human body detection area having been set.

The parameter setting unit 205 is capable of setting a human body detection processing application range in a frame and is also capable of setting the maximum size and the minimum size of each detection target human body. Further, the parameter setting unit 205 is capable of setting various parameters required for the recognition processing according to a user operation. For example, the parameter setting unit 205 can automatically set the required parameters based on results of the recognition processing applied to the previously processed frames.

Further, the parameter setting unit 205 can perform not only human body detection settings for the human body detection unit 204 but also object detection settings (e.g., detection area and/or detection size settings) for the object detection unit 202. In the present exemplary embodiment, an object detection range of the object detection unit 202 is the entire frame. In general, the object detection processing can be terminated at early timing when the detection range is narrowed.

The object associating unit 206 can associate an object (i.e., a substance) detected by the object detection unit 202 with a human body detected by the human body detection unit 204. More specifically, the object associating unit 206 according to the present exemplary embodiment compares an overlap rate between a bounding rectangle of the object detected by the object detection unit 202 and an area of the human body detected by the human body detection unit 204 with a predetermined threshold value and performs associating processing between the object and the human body based on a comparison result.

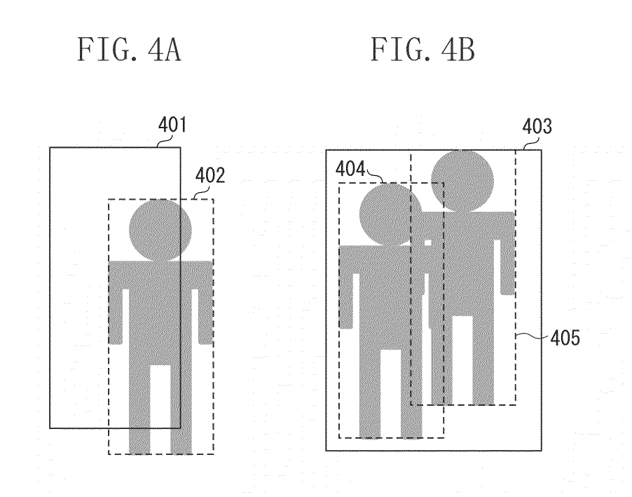

An example of the associating processing between an object and a human body will be described in detail below with reference to FIGS. 4A and 4B. FIG. 4A illustrates an example state where the overlap rate between a bounding rectangle 401 of the object detected by the object detection unit 202 and a bounding rectangle 402 of the human body detected by the human body detection unit 204 is less than the threshold value. The overlap rate in the present exemplary embodiment is a rate of an overlap area (or size) between the bounding rectangle 401 of the object and the bounding rectangle 402 of the human body in relation to the area (i.e., size) of the bounding rectangle 402 of the human body. However, the overlap rate calculation method is not limited to the above-mentioned example. If it is determined that the overlap rate between the bounding rectangle 401 and the bounding rectangle 402 is lower than the threshold value, the object associating unit 206 according to the present exemplary embodiment does not perform the associating processing between the object corresponding to the bounding rectangle 401 and the human body corresponding to the bounding rectangle 402.

On the other hand, FIG. 4B illustrates another example state where a plurality of human bodies has been detected from a bounding rectangle 403 of the object detected by the object detection unit 202. In this case, the object associating unit 206 calculates an overlap rate between a bounding rectangle 404 of one human body and the object bounding rectangle 403 and an overlap rate between a bounding rectangle 405 of another human body and the object bounding rectangle 403. Then, the object associating unit 206 compares the calculated values with threshold values.

In the example illustrated in FIG. 4B, the object associating unit 206 calculates a first rate that represents a rate of an overlap area (or size) between the object bounding rectangle 403 and the human body bounding rectangle 404 in relation to the entire area (or size) of the human body bounding rectangle 404. Further, the object associating unit 206 calculates a second rate that represents a rate of the overlap area (or size) between the object bounding rectangle 403 and the human body bounding rectangle 405 in relation to the entire area (or size) of the human body bounding rectangle 405. As illustrated in FIG. 4B, each of the first and second rates is 100%. Accordingly, the object associating unit 206 associates the object corresponding to the bounding rectangle 403 with the human body corresponding to the bounding rectangle 404. Further, the object associating unit 206 associates the object corresponding to the bounding rectangle 403 with the human body corresponding to the bounding rectangle 405.

The locus managing unit 207 can manage object information acquired from the object detection unit 202 and the object follow-up unit 203, as management information, for each object. More specifically, the locus managing unit 207 acquires object information (e.g., positional information, bounding rectangle information, and size information about each object) generated by the object detection unit 202 and information about object ID allocated by the object follow-up unit 203. The locus managing unit 207 manages the acquired information.

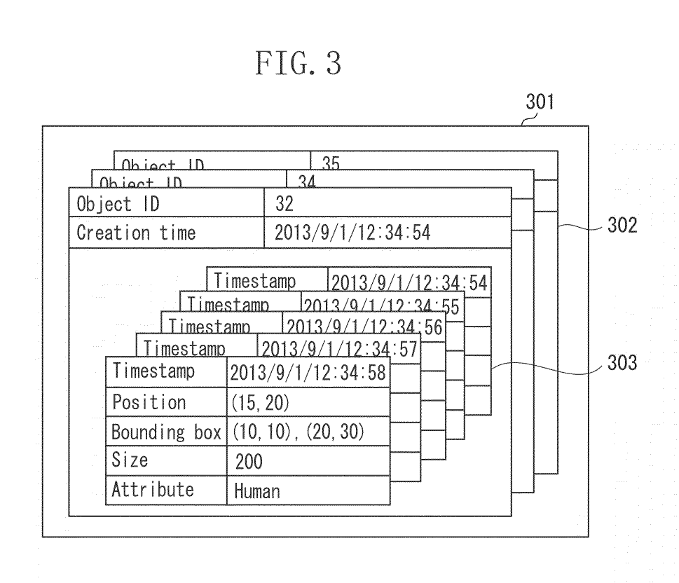

Information management that can be performed by the locus managing unit 207 will be described in detail below with reference to FIG. 3. FIG. 3 illustrates an example state of object information 302 managed for each object ID. The object information 302 corresponding to one object includes management information 303 for each frame in which the above-mentioned object has been detected. Each information 303 includes time stamp (see “Time Stamp”), coordinate position (see “Position”), bounding rectangle information (see “Bounding box”), object size (see “Size”), and object attribute (see “Attribute”). The time stamp indicates creation date and time of the information 303. The coordinate position indicates centroid coordinates of the object. The bounding rectangle information indicates a minimum rectangle that entirely encompasses the object. However, the information types included in the information 303 are not limited to the above-mentioned examples. The information 303 can include various types of other information. The management information managed by the locus managing unit 207 can be used by the locus information determining unit 208.

The locus managing unit 207 can update the object attribute (see “Attribute”) according to an association result obtained by the object associating unit 206. For example, in a case where the attribute of a first object detected from a first frame is a material body (i.e., a non-human body) and the attribute of a second object detected from a second frame that follows the first frame is a human body, the locus managing unit 207 updates the object attribute in the following manner. More specifically, if the same object ID is allocated to both of the first and second objects, the locus managing unit 207 changes the attribute corresponding to the first object to the human body (see “Human”).

Further, even when no human body is associated with a third object detected from a third frame that follows the second frame, the locus managing unit 207 can set attribute of the third object to the human body if the same object ID is allocated to the second and third objects. Through the above-mentioned operation, objects having the same object ID can have the same attribute at any time.

The locus information determining unit 208 can perform predetermined event detection processing using an event detection parameter set by the parameter setting unit 205 and the management information managed by the locus managing unit 207. The predetermined event is, for example, a crossing event or an entry event. When the locus information determining unit 208 performs crossing event detection processing, the event detection parameter is a parameter that can identify a detection line to be used in the crossing event detection processing. The locus information determining unit 208 detects an occurrence of the crossing event with reference to information relating to the detection line set by the parameter setting unit 205 and information relating to movement locus of each object identified based on the management information.

Further, when the locus information determining unit 208 performs entry event detection processing, the event detection parameter is a parameter that can identify an entry area to be detected as the entry event. The locus information determining unit 208 detects an occurrence of the entry event with reference to the area related information set by the parameter setting unit 205 and positional information about each object identified from the management information. The event is not limited to the crossing event and the entry event. For example, it is feasible to detect an event of a human object being moving around in a specific range. As mentioned above, the locus information determining unit 208 can perform recognition processing (e.g., event detection processing) based on object information detectable from image data.

When the locus information determining unit 208 performs the crossing event detection processing, the locus information determining unit 208 determines whether a moving vector from the bounding rectangle of a human body attribute object in a one-frame preceding frame in relation to the frame of interest to the bounding rectangle of human body attribute object in the frame of interest intersects with the detection line. It is now assumed that the same object and the same ID are allocated to each of the human body attribute object in the frame of interest and the human body attribute object in the one-frame preceding frame in relation to the frame of interest. Determining whether the moving vector intersects with the detection line corresponds to determining whether the human body attribute object has crossed the detection line. The external output unit 209 can output the determination result obtained by the locus information determining unit 208 to an external device (e.g., the display apparatus 210). Further, in a case where the external output unit 209 is functionally operable as a display unit, which is constituted by a cathode ray tube (CRT) or a liquid crystal screen, the external output unit 209 can be used to display the determination result instead of using the display apparatus 210.

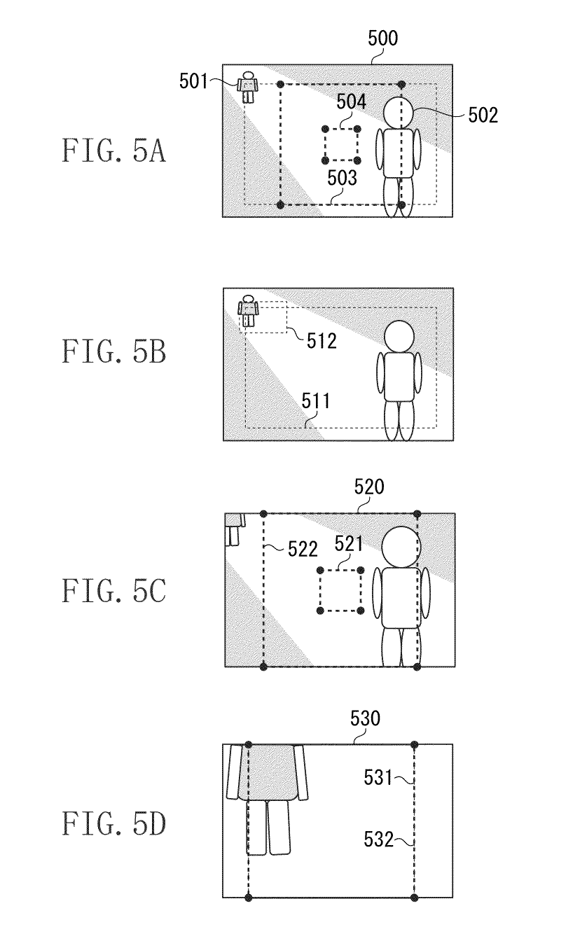

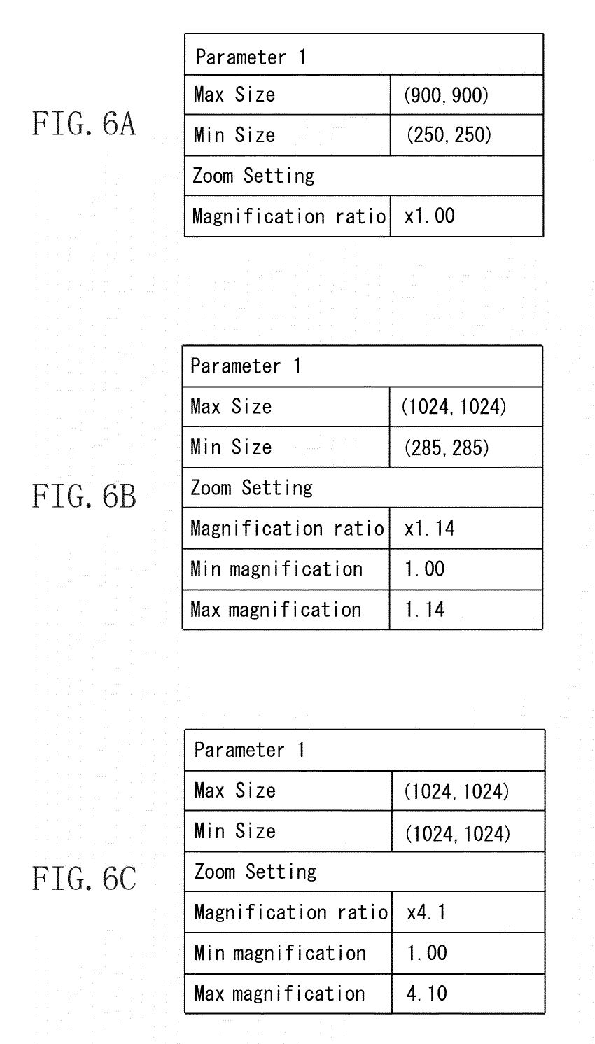

Next, size setting processing required in the human body detection according to the present exemplary embodiment will be described in detail below with reference to FIGS. 5A to 5D and 6A to 6C. FIGS. 5A to 5D illustrate a setting of a detection processing size. FIG. 5A illustrates a screen example that enables a user to set the maximum size and the minimum size of each detection target human body.

FIG. 5A illustrates a setting screen 500 of a setting tool that sets human body detection parameters. The scene displayed on the screen 500 includes a road extending from a screen upper left position to a screen lower right position, together with a human body 501 located on an upper left side (i.e., a far side) and a human body 502 located on a lower right side (a near side). A setting rectangle 503 is a user interface (UI) that enables a user to set a desired maximum size of the detection target human body. Similarly, a setting rectangle 504 is an UI that enables a user to set a desired minimum size of the detection target human body. In other words, the setting screen 500 enables a user to set a desired size (or range) of the detection target human body by setting the setting rectangles 503 and 504. Performing the above-mentioned operation is effective in reducing the processing load relating to the human body detection and also reducing the possibility of error detection. Each operator (i.e., a user) can change the size of respective setting rectangles 503 and 504 by performing a mouse operation (or a drag operation) on a boundary line or a node of each setting rectangle 503 or 504. The parameter setting unit 205 can set the maximum size and the minimum size of a detection target human object according to an operation of a user who sets respective sizes of the setting rectangles 503 and 504.

FIGS. 6A to 6C illustrate examples of parameters that can be set by the parameter setting unit 205. FIG. 6A illustrates setting values of the setting rectangles 503 and 504. According to the example illustrated in FIG. 6A, the maximum size (see “Max Size”) and the minimum size (see “Min Size”) of the detection target human body are (900,900) in terms of pixel and (250,250) in terms of pixel, respectively. More specifically, the maximum size of the detection target human body has a width of 900 pixels and a height of 900 pixels. The minimum size of the detection target human body has a width of 250 pixels and a height of 250 pixels. Further, resolutions of the screen 500 are 1280 pixels in width and 1024 pixels in height. According to the example illustrated in FIG. 6A, the zoom magnification is ×1. More specifically, resolutions of the imaging unit are 1280 pixels in width and 1024 pixels in height.

If the screen 500 is zoomed up after the settings illustrated in FIG. 6A have been completed, a human body in a captured image becomes greater correspondingly. Therefore, the parameter setting unit 205 according to the present exemplary embodiment changes the maximum size and the minimum size of the detection target human body according to a change in zoom magnification (i.e., zoom value). More specifically, if a user performs a zoom-up operation after the setting rectangles 503 and 504 have been set, the parameter setting unit 205 enlarges the maximum size and the minimum size of the detection target according to an increase in zoom magnification. However, if the zoom magnification is excessively increased in the above-described control, the maximum size of the detection target human object may excurse from the imaging range.

More specifically, if the zoom magnification (i.e., the zoom value) is excessively increased after the maximum size of the detection target human body has been set, a human body corresponding to the above-mentioned maximum size may not be successfully detected. Therefore, the zoom control unit 211 according to the present exemplary embodiment restricts a changeable range of the zoom magnification (i.e., the zoom value) in such a manner that the maximum size of the human body changed according to a zoom magnification change can be accommodated in the screen area (i.e., the imaging range of the imaging unit).

FIG. 5C illustrates a screen display example in which enlarging the zoom magnification is substantially restricted in such a way as to prevent the screen area, if it is enlarged from the state illustrated in FIG. 5A by a zoom-up operation, from becoming smaller than the maximum size of the human body. More specifically, if a zoom-up instruction is input in the state illustrated in FIG. 5A, the zoom control unit 211 according to the present exemplary embodiment continuously increases the zoom magnification unless the enlargement scale exceeds the state illustrated in FIG. 5C and immediately stops the zoom-up operation at the time when the enlargement scale has reached the state illustrated in FIG. 5C.

FIG. 6B illustrates an example of parameters corresponding to the state illustrated in FIG. 5C. In FIG. 6B, the zoom magnification (see “Magnification ratio”) is ×1.14. The zoom magnification indicated in FIG. 6B is a calculated zoom magnification value required to perform a zoom-up operation in such a way as to increase the maximum size of the human body from the value (i.e., height: 900 pixels) illustrated in FIG. 6A to the height (i.e., 1024 pixels) of the screen 500. The parameter setting unit 205 calculates and holds the minimum zoom magnification (see “Min magnification”) and the maximum zoom magnification (see “Max magnification”) according to the human body maximum/minimum size settings, based on the above-mentioned maximum size and the screen size. In the present exemplary embodiment, each of the maximum size and the minimum size of a target human body is defined by a rectangle. According to the example illustrated in FIG. 6B, the short-side length of the screen is equal to 1024 pixels. On the other hand, the maximum size of the human body is equal to 900 pixels. Dividing the short-side length (i.e., 1024 pixels) by the maximum human body size (i.e., 900 pixels) obtains a value 1.14 (≅1.13777). Therefore, the parameter setting unit 205 holds the obtained value 1.14 as the maximum zoom magnification. Subsequently, when a zoom operation is performed, the zoom control unit 211 controls the zoom magnification in such a way as to increase (or decrease) within a zoom magnification changeable range defined by the minimum and maximum zoom magnifications having been determined beforehand as mentioned above.

Further, as illustrated in FIG. 6B, the parameter setting unit 205 enlarges the minimum size and the maximum size of the target human body according to the zoom-up operation. Changing the maximum size/minimum size of the target human body according to a change in zoom magnification in a manner described above is useful to reduce error detection and/or detection failure possibility as described in detail below.

Although the example illustrated in FIG. 5C is characterized by controlling the zoom magnification in such a way as to prevent the maximum size from excursing from the imaging range, it is feasible to apply similar processing to the minimum size. If the similar processing is applied to limit the minimum size, it becomes feasible to increase the processing speed because it is unnecessary to perform human body detection processing for any human body that is smaller than the minimum size. FIG. 5D illustrates a screen display example in which the zoom magnification is substantially restricted in such a way as to prevent the screen area, if it is enlarged from the state illustrated in FIG. 5A by a zoom-up operation, from becoming smaller than the minimum size of the human body.

In a case where the above-mentioned operation is performed, if a zoom-up instruction is input in the state illustrated in FIG. 5A, the zoom control unit 211 continuously increases the zoom magnification unless the enlargement scale exceeds the state illustrated in FIG. 5D and immediately stops the zoom-up operation at the time when the enlargement scale has reached the state illustrated in FIG. 5D. According to the example illustrated in FIG. 5D, the zoom control unit 211 does not stop the zoom-up operation at the time when the enlargement scale has reached the state illustrated in FIG. 5C and stops the zoom-up operation at the time when the enlargement scale has reached the state illustrated in FIG. 5D.

FIG. 6C illustrates an example of parameters corresponding to the state illustrated in FIG. 5D. In FIG. 6C, the zoom magnification (see “Magnification ratio”) is ×4.10. The zoom magnification indicated in FIG. 6C is a calculated zoom magnification value required to perform a zoom-up operation in such a way as to increase the minimum size of the human body from the value (i.e., height: 250 pixels) illustrated in FIG. 6A to the height (i.e., 1024 pixels) of the screen 500. The parameter setting unit 205 calculates and holds the minimum zoom magnification (see “Min magnification”) and the maximum zoom magnification (see “Max magnification”) according to the human body maximum/minimum size settings, based on the above-mentioned minimum size and the screen size. In the present exemplary embodiment, each of the maximum size and the minimum size of a target human body is defined by a rectangle. According to the example illustrated in FIG. 6C, the short-side length of the screen is equal to 1024 pixels. On the other hand, the minimum size of the human body is equal to 250 pixels. Dividing the short-side length (i.e., 1024 pixels) by the minimum human body size (i.e., 250 pixels) obtains a value 4.10 (≅4.09). Therefore, the parameter setting unit 205 holds the obtained value 4.10 as the maximum zoom magnification. Subsequently, when a zoom operation is performed, the zoom control unit 211 controls the zoom magnification in such a way as to increase (or decrease) within a zoom magnification changeable range defined by the minimum and maximum zoom magnifications having been determined as mentioned above.

An example change of the maximum size and the minimum size of a target human body according to a change in zoom value (i.e., zoom magnification) illustrated in FIG. 6C will be described in detail below. A screen 520 illustrated in FIG. 5C includes a captured human body having been increased by a zoom-up operation. Therefore, a human body that is greater than the setting rectangle 503 illustrated in FIG. 5A (corresponding to “Max Size” illustrated in FIG. 6A) may be captured as a human body to be detected in the zoom-up operation. However, there will be a possibility that a larger human body cannot be detected if the “Max Size” illustrated in FIG. 6A is directly applied. Similarly, even though the captured human body becomes greater due to the zoom-up operation, if the “Min Size” illustrated in FIG. 6A is directly applied, there will be a possibility that an object having a size not assumed as a detection target at the parameter setting timing may be detected as a human body. In other words, there is a possibility that the processing load relating to the human body detection processing may increase or an undesirable detection result may be obtained.

Similar inconveniences occur in a zoom-out operation. More specifically, a captured human body becomes smaller when a zoom-out operation is performed. However, if the minimum size of the human body remains the same compared to the setting value being set before performing the zoom-out operation, there will be a possibility of failing in the detection. Further, in a case where the captured human body becomes smaller due to the zoom-out operation, if the maximum size of the human body is not changed, there will be a possibility that an object having a size not assumed as a detection target at the parameter setting timing may be detected as a human body. In other words, there is a possibility that the processing load relating to the human body detection processing may increase or an undesirable detection result may be obtained.

Therefore, the parameter setting unit 205 according to the present exemplary embodiment changes the minimum size and the maximum size of the human body according to a change in zoom magnification. FIG. 5C illustrates an example of the zoom-up operation performed in such a way as to enlarge the setting rectangles 503 and 504 illustrated in FIG. 5A to setting rectangles 522 and 521.

When the zoom control unit 211 performs a zoom-up operation in such a way as to shift the screen 500 illustrated in FIG. 5A to the screen 520 illustrated in FIG. 5C, the magnification value in the zoom-up operation is approximately ×1.14 as illustrated in FIG. 6B. The parameter setting unit 205 changes the maximum size and the minimum size according to the zoom-up operation. The minimum size (285, 285) illustrated in FIG. 6B is approximately 1.14 times the minimum size illustrated in FIG. 6A. Further, the maximum size (1024, 1024) is equal to the upper limit of the vertical screen size.

Further, when the zoom control unit 211 performs a zoom-up operation in such a way as to shift from the screen 500 illustrated in FIG. 5A to a screen 530 illustrated in FIG. 5D, the magnification in the zoom-up operation is approximately ×4.10 as illustrated in FIG. 6C. The minimum size (1024, 1024) illustrated in FIG. 6C is 4.10 times the minimum size illustrated in FIG. 6A. Further, the maximum size (1024, 1024) is equal to the upper limit of the vertical screen size, although it should be approximately 4.10 times the maximum size illustrated in FIG. 6A.

The parameter setting unit 205 according to the present exemplary embodiment performs parameter (e.g., maximum size/minimum size of human body) change processing according to a change in zoom magnification and notifies the processing result to the setting tool. The setting tool changes the size of respective setting rectangles as illustrated in FIGS. 5A and 5C. When the parameter setting unit 205 performs the above-mentioned operation, a user of the setting tool can check and confirm the latest maximum size/minimum size of the human body having been changed according to the change in zoom magnification.

The control apparatus according to the present exemplary embodiment sets a zoomable range (i.e., zoom magnification changeable range) according to a parameter being set and performs a zoom control in such a way as to prevent the zooming scale from excursing from the zoomable range. However, in a case where the zoom operation excurses from the zoomable range, the control apparatus can display a warning (e.g., on the setting tool) while continuing the zoom control. Alternatively, in a case where the zoom operation excurses from the zoomable range, the control apparatus can stop the human body detection processing and continue the zoom control. Further, in a case where the zoom operation excurses from the zoomable range, the control apparatus can disable the zoom control and display a warning (e.g., on the setting tool).

Further, although a rectangular area is set to detect a human body in the present exemplary embodiment, the detection area is not limited to the above-mentioned example. For example, the shape of each human body detection area can be a polygon, a circle, or any other shape.

Further, in the present exemplary embodiment, the minimum size and the maximum size of a target human body are employed as parameters to be used in calculating the zoomable range (i.e., zoom magnification changeable range). However, it is feasible to employ any other parameter variable depending on the size of a captured image or the position on an image. For example, in a case where similar objects appear continuously in a plurality of frames, the object follow-up unit 203 checks the distance between a predicted object position estimated based on the moving vector and an actually detected object position as mentioned above. If the obtained distance is less than the predetermined value, the object follow-up unit 203 identifies the compared objects as the same object. In view of the foregoing, it is feasible to determine the zoomable range according to the parameter relating to the above-mentioned predetermined distance.

Further, in a case where setting a minimum moving speed and a maximum moving speed of a detection target object (e.g., a human body) on the screen is feasible, it is useful to determine the zoomable range based on the maximum moving speed and the minimum moving speed.

More specifically, if the control apparatus performs a zoom-up operation until the difference between the predicted object position estimated based on the moving vector and the actually detected object position exceeds the imaging screen length, it may become difficult to identify two objects as the same object even if these objects are actually the same one. In this case, because the follow-up processing cannot be performed, measuring the moving speed of an object on the screen becomes unfeasible. Therefore, the parameter setting unit 205 can be configured to determine the zoomable range according to the setting of the minimum moving speed and the maximum moving speed of a target object (human body) so that the measurement of the object moving speed can be prevented from failing.

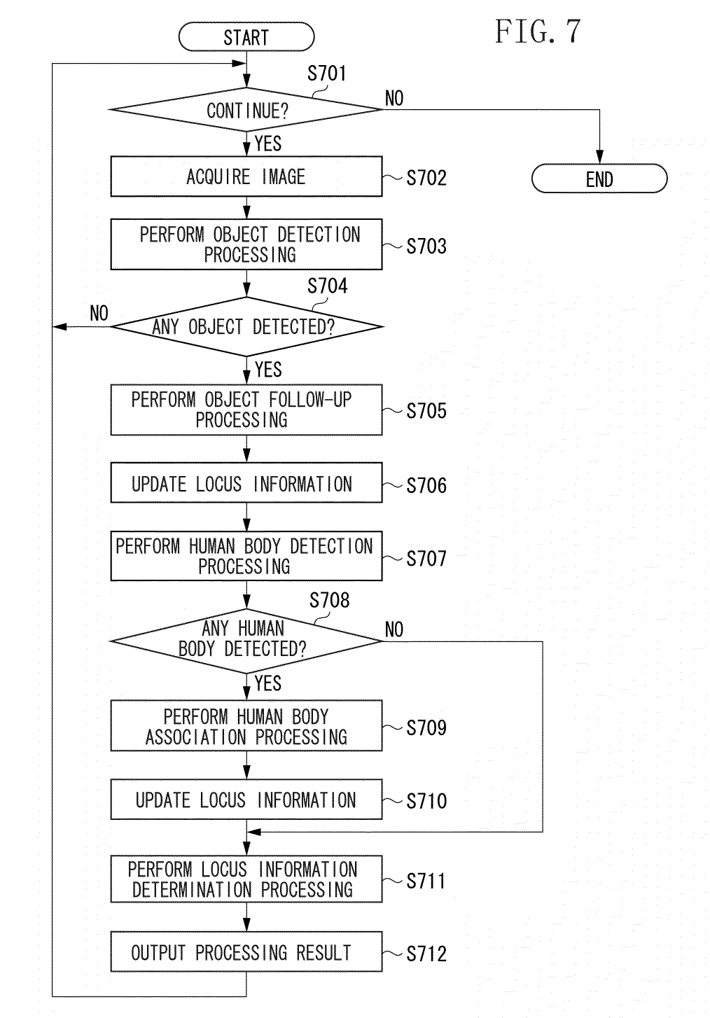

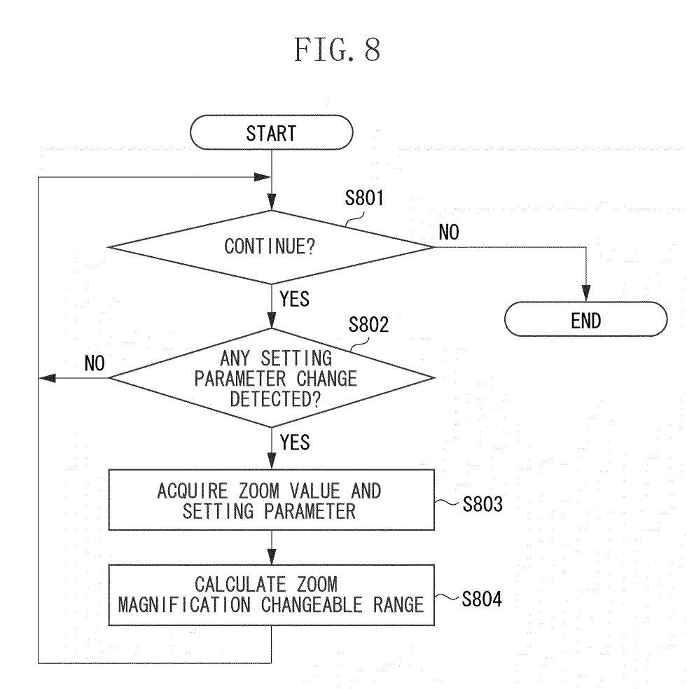

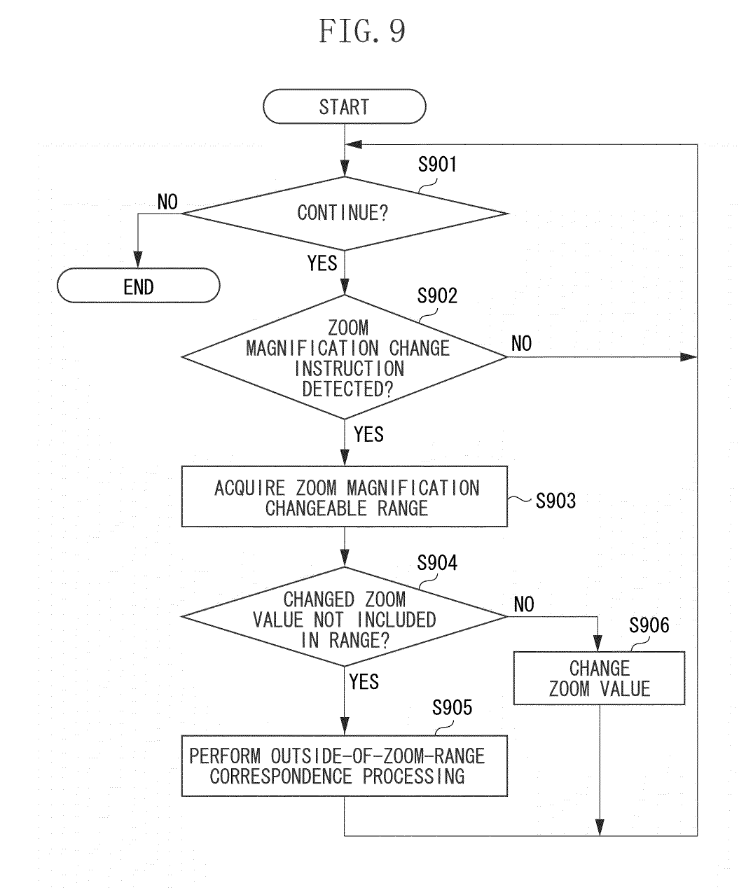

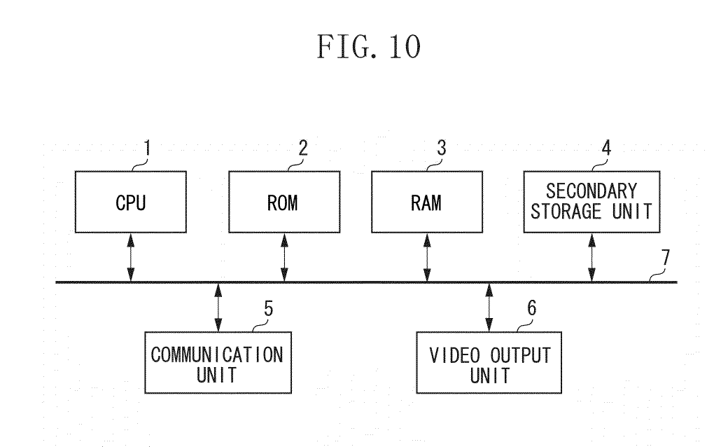

Next, an operation that can be performed by the control apparatus 200 according to the present exemplary embodiment will be described in detail below with reference to a flowchart illustrated in FIG. 7. The control apparatus 200 according to the present exemplary embodiment uses a dedicated hardware to perform processing relating to the flowchart illustrated in FIG. 7. Alternatively, a central processing unit (CPU) of the control apparatus 200 can read and execute a software program that performs the processing relating to the flowchart illustrated in FIG. 7. FIG. 10 illustrates a configuration of the control apparatus 200 employable in a case where the control apparatus 200 uses the CPU to perform the processing of the flowchart illustrated in FIG. 7. The control apparatus 200 can be configured similarly to perform processing of flowcharts illustrated in FIGS. 8 and 9.

The control apparatus 200 starts the processing of the flowchart illustrated in FIG. 7 in response to a shooting start instruction having been input by a user. In step S701, the control apparatus 200 determines whether to continue the above-mentioned processing. For example, the control apparatus 200 can determine the continuation of the processing by checking whether a processing termination instruction has been received from a user. If the control apparatus 200 determines to continue the processing (YES in step S701), the operation proceeds to step S702. If it is determined to terminate the processing (NO in step S701), the control apparatus 200 terminates the processing of the flowchart illustrated in FIG. 7.

In step S702, the image acquisition unit 201 acquires image data of one frame that has been input in the control apparatus 200. The image data acquired in this case is image data obtained through an imaging operation of the imaging unit. In step S703, the object detection unit 202 performs object detection processing on the acquired image data. In step S704, the object detection unit 202 determines whether there is any object detected in step S703. If the object detection unit 202 determines that there is at least one object having been detected (YES in step S704), the operation proceeds to step S705. On the other hand, if it is determined that there is not any object having been detected (NO in step S704), the operation returns to step S701.

In step S705, the object follow-up unit 203 performs object follow-up processing. More specifically, the object follow-up unit 203 determines whether a first object detected from a first frame coincides with a second object detected from a second frame. If it is determined that the first object coincides with the second object, the object follow-up unit 203 allocates same object ID to the first object and the second object. If the first object and the second object are the same human object, the object follow-up unit 203 allocates the same object ID.

In step S706, the locus managing unit 207 updates locus information according to the follow-up processing result obtained in step S705. More specifically, the locus managing unit 207 manages the object information for each object ID as illustrated in FIG. 3. In step S706, the locus managing unit 207 updates object information corresponding to the object ID identified in step S705 with information about the object obtained in the object detection in step S704.

In step S707, the human body detection unit 204 performs human body detection processing on the object detected by the object detection unit 202 using parameters having been set by the parameter setting unit 205. Although the parameter setting unit 205 according to the present exemplary embodiment mainly sets a maximum size and a minimum size of each detection target human body as described above, the settings to be performed by the parameter setting unit 205 are not limited to the above-mentioned examples. For example, the parameter setting unit 205 can be configured to set a maximum size and a minimum size of a non-human object (e.g., a vehicle or an animal). More specifically, the human body detection unit 204 acquires parameters required in the recognition processing from the parameter setting unit 205 and performs recognition processing based on the acquired parameters.

In step S708, the human body detection unit 204 determines whether there is any human body detected in step S707. If the human body detection unit 204 determines that at least one human body has been detected (YES in step S708), the operation proceeds to step S709. On the other hand, if the human body detection unit 204 determines that there is not any human body having been detected (NO in step S708), the operation proceeds to step S711.

In step S709, the object associating unit 206 performs processing for associating the object with the human body. More specifically, the object associating unit 206 calculates an overlap rate between a bounding rectangle of the object detected by the object detection unit 202 and a bounding rectangle of the human body detected by the human body detection unit 204. Then, the object associating unit 206 associates the object with the human body based on a comparison result between the obtained overlap rate and a threshold value.

In step S710, the locus managing unit 207 updates the locus information based on the association result obtained in step S709. More specifically, after completing the processing for associating the object with the human body in step S709, the locus managing unit 207 describes human body (see “Human”) in the field of the above-mentioned object attribute (see “Attribute”).

In step S711, the locus information determining unit 208 performs locus information determination processing and determines whether the object has crossed the detection line. More specifically, the locus information determining unit 208 determines whether the above-mentioned object has crossed the detection line based on positional information about the object to which the same object ID is allocated, in each frame. The recognition processing to be performed by the locus information determining unit 208 is not limited to the above-mentioned detection line crossing event detection. For example, it is feasible to detect an event of an object having entered a specific area.

In step S712, the external output unit 209 outputs a determination result to an external device according to the determination result obtained in step S711. The external output unit 209 according to the present exemplary embodiment causes the display apparatus 210 to output a warning message when the locus information determining unit 208 determines that the object has crossed the detection line.

Next, zoom magnification changeable range determination processing that can be performed by the control apparatus 200 will be described in detail below with reference to a flowchart illustrated in FIG. 8. For example, the control apparatus 200 starts the processing of the flowchart illustrated in FIG. 8 in response to launching of the setting tool that changes the parameters of the image data recognition processing.

First, in step S801, the parameter setting unit 205 of the control apparatus 200 determines whether to continue the processing illustrated in FIG. 8. For example, in determining whether to continue the processing, the parameter setting unit 205 can check if an instruction to terminate the parameter setting processing has been received from a user interface. If the parameter setting unit 205 determines to continue the processing (YES in step S801), the operation proceeds to step S802. On the other hand, if it is determined to terminate the processing (NO in step S801), the parameter setting unit 205 terminates the processing of the flowchart illustrated in FIG. 8.

In step S802, the parameter setting unit 205 detects the presence of any change in the setting parameter. If the parameter setting unit 205 determines that there is a parameter having been changed (YES in step S802), the operation proceeds to step S803. On the other hand, if it is determined that there is not any change in the parameter (NO in step S802), the operation returns to step S801. For example, if the size of the setting rectangle 503 or 504 illustrated in FIGS. 5A to 5D is changed by a user operation and then if an instruction to finalize the above-mentioned change is input, the parameter setting unit 205 determines that the parameter has changed. However, in this case, the processing to be performed by the parameter setting unit 205 is not limited to the above-mentioned example. For example, if the position or length of the detection line is changed by a user operation, or if the position or size of the entry event detection area is changed by a user operation, the parameter setting unit 205 determines that the parameter has changed.

In step S803, the zoom control unit 211 acquires the present zoom magnification (i.e., the zoom value) and the changed parameter (i.e., the value detected in step S802). More specifically, if the determination result in step S802 reveals a change in recognition processing parameter, the zoom control unit 211 acquires the above-mentioned changed parameter and the zoom magnification at the determination timing.

More specifically, if the recognition processing to be performed on image data is detection of a specific object, then in step S803, the zoom control unit 211 acquires size information about the specific object as the recognition processing parameter. The maximum size/minimum size information about a human body corresponds to the size information about the specific object.

Further, if the recognition processing to be performed on image data is detection of an object having entered a specific area (i.e., the entry event detection), the zoom control unit 211 acquires area information relating to the position and/or size of the specific area as the recognition processing parameter.

Further, if the recognition processing to be performed on image data is detection of an object having crossed a specific detection line (i.e., the crossing event detection), the zoom control unit 211 acquires detection line information to be used in identifying the position and/or length of the detection line as the recognition processing parameter.

In a case where the control apparatus 200 performs a plurality of types of recognition processing on image data, the zoom control unit 211 acquires parameters required in the plurality of types of recognition processing. If the zoom control unit 211 completes the acquisition of the parameters for the recognition processing to be performed, the operation proceeds to step S804.

In step S804, the zoom control unit 211 calculates a zoom magnification changeable range based on the zoom magnification (i.e., zoom value) acquired in step S803 and the changed parameter.

For example, in a case where the maximum size of the detection target human body is set to be 900 pixels in height and 900 pixels in width when the zoom magnification is ×1, the zoom control unit 211 determines that the minimum zoom magnification should be ×1 and the maximum zoom magnification should be ×1.14. In this case, it is assumed that the imaging unit and the display apparatus 210 have the resolution of 1280 pixels in width and 1024 pixels in height. Further, if the maximum size of the human body has been increased to 1000 pixels in height and 1000 pixels in width, the zoom control unit 211 determines that the minimum zoom magnification should be ×1 and the maximum zoom magnification should be ×1.024. Further, for example, if the maximum size of the human body has been reduced from the initial dimensions of 900 pixels in height and 900 pixels in width to new dimensions of 600 pixels in height and 600 pixels in width, the zoom control unit 211 determines that the minimum zoom magnification should be ×1 and the maximum zoom magnification should be ×1.71. If the setting of the zoom magnification changeable range (i.e., the processing in step S804) completes, the operation returns to step S801. The zoom magnification changeable range determined in step S804 can be stored in the control apparatus 200 and can be used in a zoom magnification control that will be subsequently performed.

The zoom magnification changeable range calculation (or determination) method is variable depending on the type of recognition processing to be performed on image data or parameter to be set for the recognition processing. For example, the zoom control unit 211 can determine the zoom magnification changeable range based on the minimum size of a detection target human body. For example, in a case where the minimum size of the target human body is set be 250 pixels in height and 250 pixels in width, the zoom control unit 211 determines that the minimum zoom magnification should be ×1 and the maximum zoom magnification should be ×4.1. Further, if the minimum size of the target human body has been changed to 500 pixels in height and 500 pixels in width, the zoom control unit 211 determines that the minimum zoom magnification should be ×1 and the maximum zoom magnification should be ×2.05. As mentioned above, when the zoom control unit 211 determines the zoom magnification changeable range based on the minimum size (not the maximum size) of the detection target human body, there is a possibility that the maximum size obtainable through the change of zoom magnification may excurse from the imaging range of the imaging unit, even when the zoom magnification is changed within the above-mentioned range. However, the degree of freedom in changing the zoom magnification can be enhanced. Further, it is useful to enable a user to select between the zoom magnification changeable range determination based on the maximum size and the zoom magnification changeable range determination based on the minimum size.

Further, if the recognition processing to be performed on image data is the entry event detection, the zoom control unit 211 changes the size of a specific area to be used in the entry event detection according to a change of the zoom magnification. In this case, the zoom control unit 211 determines the zoom magnification changeable range in such a way as to prevent the size of the specific area having been changed according to the zoom magnification change from exceeding the size of the imaging range (i.e., the display screen) of the imaging unit. More specifically, the zoom control unit 211 determines the zoom magnification changeable range based on area information relating to the entry event. In the case of setting a plurality of specific areas, the zoom control unit 211 can determine the zoom magnification changeable range based on the largest specific area.

Further, if the recognition processing to be performed on image data is the crossing event detection, the zoom control unit 211 changes the length of a detection line to be used in the crossing event detection according to a change of the zoom magnification. In this case, the zoom control unit 211 determines the zoom magnification changeable range in such a way as to prevent the size of the detection line having been changed according to the zoom magnification change from exceeding the size of the imaging range (i.e., the display screen) of the imaging unit. More specifically, the zoom control unit 211 determines the zoom magnification changeable range based on detection line information relating to the crossing event. In the case of setting a plurality of detection lines, the zoom control unit 211 can determine the zoom magnification changeable range based on the largest detection line.

As mentioned above, when the zoom magnification is increased, the zoom control unit 211 according to the present exemplary embodiment can change the parameter according to the zoom magnification change in such a way as to realize a size enlargement that corresponds to the recognition processing parameter. Further, the zoom control unit 211 can determine a range in which the size corresponding to the parameter change according to the zoom magnification change does not excurse from the imaging range of the imaging unit as the zoom magnification changeable range.

Next, zoom magnification change processing that can be performed by the control apparatus 200 will be described in detail below with reference to a flowchart illustrated in FIG. 9. The control apparatus 200 starts the processing of the flowchart illustrated in FIG. 9 in response to a shooting start instruction input by a user. First, in step S901, the control apparatus 200 determines whether to continue the processing illustrated in FIG. 9. For example, the control apparatus 200 can determine the continuation of the processing by checking whether a processing termination instruction has been received from a user. If the control apparatus 200 determines to continue the processing (YES in step S901), the operation proceeds to step S902. If it is determined to terminate the processing (NO in step S901), the control apparatus 200 terminates the processing of the flowchart illustrated in FIG. 9.

In step S902, the zoom control unit 211 checks the presence of a zoom magnification change instruction. For example, the zoom magnification change instruction can be input by a user operation. However, the operation to be performed in this case is not limited to the above-mentioned example. For example, it may be useful to perform an automatic zoom magnification control to follow up a specific object included in a captured image. If the zoom control unit 211 has detected the zoom magnification change instruction (YES in step S902), the operation proceeds to step S903. On the other hand, if the zoom magnification change instruction has not been detected (NO in step S902), the operation returns to step S901.

In step S903, the zoom control unit 211 acquires a zoom magnification changeable range. The zoom magnification changeable range can be determined by the parameter setting unit 205 in the processing illustrated in FIG. 8 and stored in the control apparatus 200. In step S904, the zoom control unit 211 determines whether a zoom value (i.e., zoom magnification) changed according to the zoom magnification change instruction acquired in step S902 is not included in the zoom magnification changeable range acquired in step S903.

If the zoom control unit 211 determines that the zoom value (i.e., zoom magnification) changed according to the zoom magnification change instruction is not included in the zoom magnification changeable range (YES in step S904), the operation proceeds to step S905. On the other hand, if it is determined that the changed zoom magnification is included in the zoom magnification changeable range (NO in step S904), the operation proceeds to step S906.

In step S905, the zoom control unit 211 performs outside-of-zoom-range correspondence processing. The outside-of-zoom-range correspondence processing is, for example, cancelling the zoom control (i.e., ignoring the zoom magnification change instruction), temporarily stopping the human body detection processing, or display of a notification or warning for an operator. The zoom control unit 211 according to the present exemplary embodiment performs at least one of the above-mentioned plurality of types of outside-of-zoom-range correspondence processing according to a content having been set beforehand by a user operation.

More specifically, when the zoom control unit 211 changes the zoom magnification according to the zoom magnification change instruction, the zoom control unit 211 performs at least one of a plurality of types of processing described below if the changed zoom magnification excurses from the zoom magnification changeable range. If the selected processing is first processing, the zoom control unit 211 ignores the above-mentioned zoom magnification change instruction and does not change the zoom magnification. If the selected processing is second processing, the zoom control unit 211 stops the recognition processing to be performed on image data although the zoom control unit 211 performs the zoom magnification change processing according to the zoom magnification change instruction. Performing the second processing is effective in preventing the recognition processing load from increasing excessively because it is unnecessary to perform the human body detection processing if a target body has a size not intended by a user, for example, due to the zoom magnification change.

If the selected processing is third processing, the zoom control unit 211 notifies a user of the zoom magnification having excursed from the zoom magnification changeable range due to the change according to the zoom magnification change instruction. More specifically, if an input zoom magnification change instruction causes the zoom magnification to excurse from the zoom magnification changeable range, the zoom control unit 211 outputs a notification indicating that changing the zoom magnification based on the above-mentioned change instruction is currently restricted. For example, it is useful to display a message for the above-mentioned notification. Alternatively, similar notification can be realized by means of an alarm or a lamp indication. In this case, the zoom control unit 211 can continue the zoom magnification change processing while performing the notification. On the other hand, the zoom control unit 211 can ignore the zoom magnification change instruction.

In step S906, the zoom control unit 211 performs a zoom magnification control based on the value indicated by the zoom magnification change instruction. If the zoom control unit 211 completes the processing in step S905 or in step S906, the operation returns to step S901.

As mentioned above, the control apparatus 200 according to the present exemplary embodiment can acquire at least one parameter (e.g., maximum size of detection target human body) required to perform recognition processing on image data obtained through an imaging operation of the imaging unit. Further, the control apparatus 200 can control the change in zoom magnification of the imaging unit according to the acquired recognition processing parameter. For example, in a case where the maximum size of a target human body has been set beforehand as the recognition processing parameter and then the maximum size is later increased according to a zoom-up operation, the control apparatus 200 can perform a control in a manner described above to prevent the maximum size from excursing from the display screen of the display apparatus 210 (i.e., the imaging range of the imaging unit). Further, for example, in a case where the minimum size of a detection target human body has been set beforehand as the recognition processing parameter and then the minimum size is later increased according to a zoom-up operation, the control apparatus 200 can perform a control in such a way as to prevent the minimum size from excursing from the display screen of the display apparatus 210 (i.e., the imaging range of the imaging unit).

For example, in a case where the control apparatus 200 detects a human body from image data obtained by a monitoring camera, performing the above-mentioned processing brings an effect of reducing error detection and/or detection failure that may occur when the maximum size/minimum size of the target human body changes according to a change in zoom magnification.

According to the example mainly described in the above-mentioned exemplary embodiment, the control apparatus 200 determines the zoom magnification changeable range based on a recognition processing parameter and restricts the change in zoom magnification based on the changeable range. However, the processing to be performed by the control apparatus 200 is not limited to the above-mentioned example. For example, the control apparatus 200 can be configured to stop or cancel the zoom magnification change processing after the setting of the parameter for the image data recognition processing is completed.

Further, according to the example mainly described in the above-mentioned exemplary embodiment, the camera has an optical zoom function and the control apparatus prevents the optical zooming mechanism from changing undesirably. However, the above-mentioned processing according to the preferred embodiment can be also applied to a digital zoom control. The present exemplary embodiment produces the effect of enabling the control apparatus to appropriately perform recognition processing on video captured by an imaging unit having a zoom magnification change function.

### OTHER EMBODIMENTS

Embodiment(s) of the present inventions can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-127534, filed Jun. 20, 2014, which is hereby incorporated by reference herein in its entirety.

What is claimed is:

1. A control apparatus comprising:
an acquisition unit configured to acquire size information designated by a user, which is information about a size designated for recognition processing to be performed on an image captured by an imaging unit;
a change unit configured to change the size corresponding to the size information acquired by the acquisition unit according to a change in zoom magnification of the imaging unit; and
a determination unit configured to determine a zoom magnification changeable range of the imaging unit according to the size information acquired by the acquisition unit.

2. The control apparatus according to claim 1, wherein the size information acquired by the acquisition unit includes a size of a human body to be detected from the captured image.

3. The control apparatus according to claim 1, wherein the size information acquired by the acquisition unit includes area designation information that indicates a size of a human body detection range defined in the captured image.

4. The control apparatus according to claim 1, wherein the size information acquired by the acquisition unit includes line designation information that indicates a size of a detection line being set to detect a presence of an object passing in the captured image.

5. The control apparatus according to claim 1, wherein the size information acquired by the acquisition unit includes area information that indicates a size of an entry detection area being set in the captured image to detect an entry of an object.

6. The control apparatus according to claim 1, wherein:
the change unit is further configured to enlarge the size corresponding to the size information if the zoom magnification is controlled in such a way as to have a larger value compared to when the value for the zoom magnification does not become larger and reduce the size corresponding to the size information if the zoom magnification is controlled in such a way as to have a smaller value compared to when the value for the zoom magnification does not become smaller, and
the determination unit is further configured to determine the zoom magnification changeable range in such a way as to prevent the size changed by the change unit from exceeding a size corresponding to an imaging range of the imaging unit.

7. The control apparatus according to claim 1, further comprising:
a notification unit configured to output a notification indicating that an input zoom magnification change instruction is invalid if the input zoom magnification change instruction causes the zoom magnification to excurse or digress from, and/or leave, the zoom magnification changeable range determined by the determination unit.

8. A control method comprising:
acquiring size information designated by a user, which is information about a size designated for recognition processing to be performed on an image captured by an imaging unit;
changing the size corresponding to the acquired size information according to a change in zoom magnification of the imaging unit; and
determining a zoom magnification changeable range of the imaging unit according to the acquired size information.

9. The control method according to claim 8, wherein the acquired size information includes a size of a human body to be detected from the captured image.

10. The control method according to claim 8, wherein the acquired size information includes area designation information that indicates a size of a human body detection range defined in the captured image.

11. A computer-readable storage medium storing a program for causing a computer to control an apparatus, the program comprising:
computer-executable instructions for acquiring size information designated by a user, which is information about a size designated for recognition processing to be performed on an image captured by an imaging unit;
computer-executable instructions for changing the size corresponding to the acquired size information according to a change in zoom magnification of the imaging unit; and
computer-executable instructions for determining a zoom magnification changeable range of the imaging unit according to the acquired size information.

12. The medium according to claim 11, wherein the acquired size information includes a size of a human body to be detected from the captured image.

13. The medium according to claim 11, wherein the acquired size information includes area designation information that indicates a size of a human body detection range defined in the captured image.
